(19) United States
(12) Patent Application Publication
(10) Pub. No.: US 2022/0139251 A1
(43) Pub. Date: May 5, 2022

(54) Motivational Extended Reality

(71) Applicant: AT&T Intellectual Property I, L.P., Atlanta, GA (US)

(72) Inventors: Marian Sweeney-Dillon, Austin, TX (US); Elizabeth Goldwyn Gibson, Austin, TX (US)

(73) Assignee: AT&T Intellectual Property I, L.P., Atlanta, GA (US)

(21) Appl. No.: 17/087,686

(22) Filed: Nov. 3, 2020

(51) Int. Cl. G09B 19/00; G06T 11/00; G06F 3/14; G16Y 10/75

(52) U.S. Cl. CPC G09B 19/00; G16Y 10/75; G06F 3/14; G06T 11/00

(57) ABSTRACT

A motivational extended reality system can create and store an identity token for a user. The system can associate, in a data store, the identity token with an input data source. The system can determine an idealized image of the user and can associate the idealized image with the identity token in the data store. The system can receive a real-world goal of the user and can associate the real-world goal with the identity token in the data store. The system can monitor, based upon data received from the input data source, progress towards the real-world goal. The system can determine whether the progress indicates that the real-world goal has been reached or that progress has been made by reaching a milestone associated with the goal. In response to determining that the real-world goal has been reached, the system can allow access to the idealized image.

### BACKGROUND

Social media has transformed the way people interact for better and for worse. Social media enables people to share photographs, videos, commentary, likes, and dislikes. In this manner, family and friends can keep in touch, new friendships can be made, and people can interact with famous individuals (e.g., actors, musicians, artists, scientists, news reporters, etc.) and companies in ways that were never possible before the Internet.

As the use of social media continues to rise and people continue to spend more of their time online, the idea of one's self in terms of their appearance, health, successfulness, or general worth can become skewed. In an effort to diminish this effect, many people rely on software to edit images of themselves (e.g., a self-portrait, also known colloquially as a “selfie,” or other photograph) in order to improve the way in which they are represented to the world via social media. For example, a person may use editing tools and filters (often built-in to social media applications) to make modifications to their image (e.g., thinner build, more muscular build, wider eyes, higher cheekbones, fuller lips, etc.). This culture often fosters an unrealistic view of one's self and others around them. As a result, social media can have a negative effect on one's mental health, and in severe instances, can result in mental health disorders such as body dysmorphic disorder, anxiety, and depression.

### SUMMARY

Concepts and technologies disclosed herein are directed to aspects of motivational extended reality. According to one aspect of the concepts and technologies disclosed herein, a system can include a processor and a memory. The memory can store instructions that, when executed by the processor, cause the processor, and thereby the system, to perform operations. In particular, the system can create an identity token (also referred to herein as an “idealized identity token” or “ID token”) for a user. The system can store the ID token in a data store. The system can associate, in the data store, the ID token with one or more input data sources, such as one or more Internet of Things (“IoT”) devices, one or more personal data source applications (e.g., calendar, fitness, health, mental health, journaling, video game, social media, dating, and the like), and/or one or more wearable devices (and/or associated application(s)). The system can associate, in the data store, the ID token with a network address for each of the IoT devices. The system can associate, in the data store, the ID token with a user account for each of the personal data source applications. The system also can associate, in the data store, the ID token with a network address for each of the wearable devices and/or a user account for a wearable device application.

The system can determine an idealized image of the user and associate, in the data store, the idealized image with the identity token. The idealized image can be an augmented reality image that includes a real-world image of the user with one or more augmented reality objects positioned over at least a portion of the real-world image. An augmented reality object can be or can include visual representations of clothes, accessories, costumes, different personal physical features, enhanced personal physical features, props, combinations thereof, and/or the like. The idealized image alternatively may be a virtual image such as an icon, character, or figure that represents the user as they desire to see themselves. In some embodiments, the idealized image can be used in a video game, a video, a television show, a movie, or other form of media. It is contemplated that the idealized image may be composed of multiple images, including one or more real-world images, one or more augmented reality images, one or more virtual images, or some combination thereof.

The system can receive one or more real-world goals of the user and associate, in the data store, the real-world goal(s) with the ID token. The real-world goal(s) can be established by the user. Alternatively or additionally, the real-world goal(s) can be established for the user by one or more entities such as, for example, another person, an application (e.g., one of the personal data source applications or the wearable device application), a company, or a service. The real-world goal(s) can be anything the user desires to achieve. By way of example, and not limitation, the real-world goal(s) may be related to the health of the user, such as a target weight of the user, one or more target measurements of the user (e.g., waist size, chest size, shoulder size, arm size, or leg size), a target caloric intake of the user, a target diet of the user, combinations thereof, and/or the like. The real-world goal(s) may be related to other aspects of the user and/or the user's life. For example, the real-world goal(s) may be to achieve a career goal, an education goal, or some other life goal. In some embodiments, a real-world goal can be established with additional considerations for when the user fails to meet the real-world goal. For example, a user who establishes a goal to reduce or eliminate their use of drugs, alcohol, and/or tobacco may receive a form of negative reinforcement such as their image exhibiting effects of their overuse (e.g., their image may show accelerated aging and/or other undesirable effects). Negative reinforcement may be applied to any other real-world goals, although it may find particular application to real-world goals that involve the user trying to reduce or eliminate their use of a substance or their engagement with a particular vice.

The system can receive data from the input data source(s) such as the IoT device(s), the personal data source application(s), and/or the wearable device(s). The data can be raw data received directly from one or more sensors of the IoT device(s) and/or the wearable device(s). Alternatively, the data can be formatted by the IoT device(s) and/or the wearable device(s) prior to export to the system.

The system can monitor, based upon the data, the user's progress towards reaching the real-world goals. The system can determine whether the progress towards the real-world goal indicates that the real-world goal has been reached. In response to determining that the progress towards the real-world goal indicates that the real-world goal has been reached, the system can allow access to the idealized image. If not, the system can provide feedback about how to improve progress towards achieving the goal, and additionally, the idealized token image can reflect the lack of progress.

In some embodiments, the system can receive a request to access the idealized image. The request can be made internally by the system. For example, the system may request the idealized image from the data store. The request can be made externally, such as from an IoT device, a personal data source application, a wearable device, an external display, a social media platform, an application server, a network, or the like. The system can export the idealized image in accordance with the request. For example, the system can export the idealized image to a display. The display can be part of the system or separate from the system and in communication with the system. The idealized image can be presented on the display as a still image or an extended reality image (e.g., augmented reality, virtual reality, or mixed reality). The system can export the idealized image to one or more social media platforms, one or more application servers, one or more other devices, or elsewhere.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings.

Other systems, methods, and/or computer program products according to embodiments will be or become apparent to one with skill in the art upon review of the following drawings and detailed description. It is intended that all such additional systems, methods, and/or computer program products be included within this description, be within the scope of this disclosure.

### BRIEF DESCRIPTION OF THE DRAWINGS

FIG. 1 is a diagram illustrating aspects of an illustrative operating environment in which various concepts and technologies disclosed herein can be implemented.

FIG. 2 is a flow diagram illustrating aspects of a method for implementing motivational extended reality, according to an illustrative embodiment of the concepts and technologies disclosed herein.

FIG. 3 is a diagram illustrating an illustrative computer system capable of implementing aspects of the concepts and technologies disclosed herein.

FIG. 4 is a diagram illustrating an illustrative network capable of implementing aspects of the concepts and technologies disclosed herein.

FIG. 5 is a diagram illustrating an illustrative cloud computing platform architecture capable of implementing aspects of the concepts and technologies disclosed herein.

FIG. 6 is a diagram illustrating an illustrative machine learning system capable of implementing aspects of the concept and technologies disclosed herein.

FIG. 7 is a block diagram illustrating an illustrative mobile device and components thereof capable of implementing aspects of the concepts and technologies disclosed herein.

### DETAILED DESCRIPTION

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

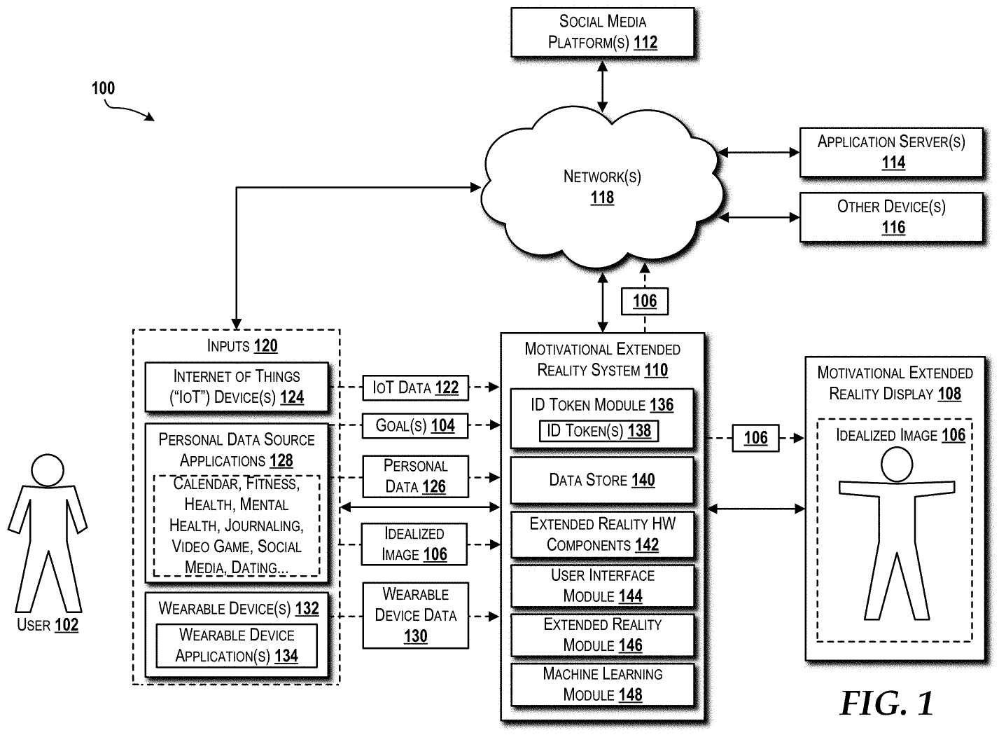

Turning now to FIG. 1, an illustrative operating environment 100 in which embodiments of various concepts and technologies disclosed herein can be implemented will be described. The operating environment 100 illustrates a user 102 who desires to augment a representation of themselves to better reflect how they would like to be perceived to themselves (e.g., a reflection in a mirror) and/or to others (e.g., a photograph shared with others via social media, messaging services, and/or the like). Currently, many people rely on software to edit images of themselves (e.g., a self-portrait, also known colloquially as a “selfie,” or other photograph) in order to improve the way in which they are represented to the world. For example, a person may use editing tools and filters (often built-in to social media applications) to make modifications to their image (e.g., thinner built, more muscular build, wider eyes, higher cheekbones, fuller lips, etc.). This culture often fosters an unrealistic view of one's self and others around them. The concepts and technologies address this issue by incorporating a motivational feedback loop through which the user 102 can make progress towards one or more real-world goals (referred to herein collectively as “goals,” or individually as “goal”) 104 to achieve an idealized image 106 of themselves. The user 102 can then share the idealized image 106 with other people, systems, devices, platforms, and/or the like. In this manner, the user 102 is rewarded for achieving the goal(s) 104 with access to the idealized image 106 of themselves. It is contemplated that each goal 104 may contain one or more milestones such that when the user 102 achieves the milestone they are rewarded by an incremental change (i.e., a portion of the idealized image 106 as used herein in the claims) to the idealized image 106 such that when the goal 104 is ultimately achieved, the end result is the final version of the idealized image 106. For example, a goal 104 to lose weight may be subdivided into milestone for each 5 pounds lost and/or for each day they meet but do not exceed their caloric goals. It is further contemplated that each goal 104 may itself be part of a larger group of goals.

The goal(s) 104 can be established by the user 102. The goal(s) 104 alternatively or additionally can be established for the user 102 by one or more entities such as, for example, another person, an application, a company, or a service. The goal(s) 104 can be anything the user 102 desires to achieve. By way of example, and not limitation, the goal(s) 104 may be related to the health of the user 102, such as a target weight of the user 102, one or more target measurements of the user 102 (e.g., waist size, chest size, shoulder size, arm size, or leg size), a target caloric intake of the user 102, a target diet of the user 102, combinations thereof, and/or the like. The goal(s) 104 may be related to other aspects of the user 102 and/or the user's 102 life. For example, the goal(s) 104 may be to achieve a career goal, an education goal, or some other life goal.

In some embodiments, the goal 104 can be established with additional considerations for when the user fails to meet the real-world goal. For example, a user who establishes a goal to reduce or eliminate their use of drugs, alcohol, and/or tobacco may receive a form of negative reinforcement such as their image exhibiting effects of their overuse (e.g., their image may show accelerated aging and/or other undesirable effects). Negative reinforcement may be applied to any other real-world goals, although it may find particular application to real-world goals that involve the user trying to reduce or eliminate their use of a substance or their engagement with a particular vice or behavior.

The idealized image 106 can be presented on a motivational extended reality display 108. The motivational extended reality display 108 can be implemented as an augmented reality display, a virtual reality display, a mixed reality display, or a display that utilizes another extended reality technology. As such, the idealized image 106 can take various forms. For example, the idealized image 106 can be an augmented reality image that includes a real-world image of the user 102 with one or more augmented reality objects positioned over at least a portion of the real-world image. An augmented reality object can be or can include visual representations of clothes, accessories, costumes, different personal physical features, enhanced personal physical features, props, combinations thereof, and/or the like. The idealized image 106 alternatively may be a virtual image such as an icon, character, or figure that represents the user 102 as they desire to see themselves. In some embodiments, the idealized image 106 can be used in a video game, a video, a television show, a movie, or other form of media. It is contemplated that the idealized image 106 may be composed of one or more real-world images, one or more augmented reality images, one or more virtual images, or some combination thereof. In some embodiments, the idealized image 106 includes an augmented reality overlay that can be superimposed upon a live video image. Similar overlays can be superimposed over a still image. In some embodiments, the idealized image 106 includes metadata that can be used to alter other images of the user 102. For example, the metadata may include instructions to apply one or more filters and/or other utilize other editing tools to modify an image of the user 102 to create the idealized image 106.

The motivational extended reality display 108 can be implemented as part of a motivational extended reality system 110. For example, in some embodiments, the motivational extended reality display 108 is an all-in-one device that incorporates both display and processing components, such as a smartphone, tablet, laptop, all-in-one computer, or all-in-one headset. In other embodiments, the motivational extended reality display 108 can be separate from the motivational extended reality system 110, such as a monitor, television, augmented reality mirror, or headset. The user 102 may desire to share the idealized image 106 with others. In these instances, the motivational extended reality display 108 may be associated with another entity such as another user. Although a display capable of extended reality applications is often described herein, other displays that simply present the idealized image 106 without any extended reality component are contemplated.

The motivational extended reality system 110 can share the idealized image 106 with one or more social media platforms 112, one or more application servers 114, and/or one or more other devices 116 via one or more networks 118. The social media platforms 112 can be platforms such as FACEBOOK, INSTAGRAM, TWITTER, YOUTUBE, SNAPCHAT, TIK-TOK, REDDIT, web forums, and the like. The application servers 114 can be server-side components of one or more client-side applications (such as those described herein below). The other devices 116 can be smartphones, tablets, computers, video game consoles, and/or the like that are associated with the user 102 and/or one or more other entities with which the user 102 desires to share the idealized image 106.

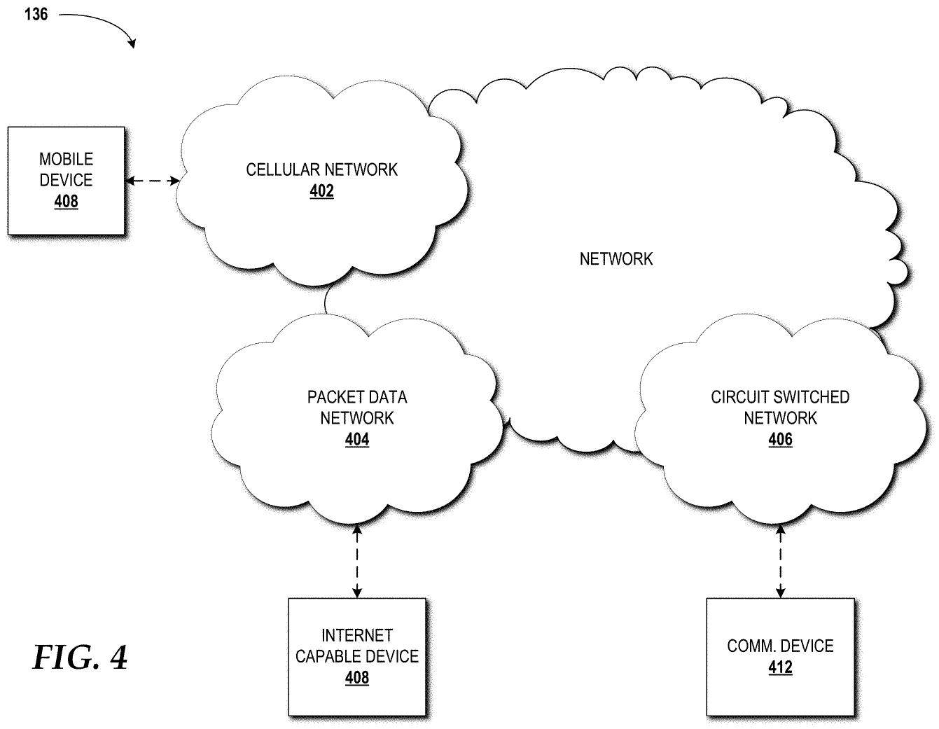

In some embodiments, the network(s) 118 can be or can include one or more wireless local area networks (“WLANs”), one or more wireless wide area networks (“WWANS”), one or more wireless metropolitan area networks (“WMANs”), one or more campus area networks (“CANs”), and/or one or more packet data networks (e.g., the Internet). The motivational extended reality system 110 can communicate with the network(s) 118 using any wireless communications technology or combination of wireless communications technologies, some examples of which include, but are not limited to, WI-FI, Global System for Mobile communications (“GSM”), Code Division Multiple Access (“CDMA”) ONE, CDMA2000, Universal Mobile Telecommunications System (“UMTS”), Long-Term Evolution (“LTE”), Worldwide Interoperability for Microwave Access (“WiMAX”), other Institute of Electrical and Electronics Engineers (“IEEE”) 802.XX technologies, and the like. The motivational extended reality system 110 can communicate with the network(s) 118 via various channel access methods (which may or may not be used by the aforementioned technologies), including, but not limited to, Time Division Multiple Access (“TDMA”), Frequency Division Multiple Access (“FDMA”), CDMA, wideband CDMA (“W-CDMA”), Orthogonal Frequency Division Multiplexing (“OFDM”), Single-Carrier FDMA (“SC-FDMA”), Space Division Multiple Access (“SDMA”), and the like. Data can be exchanged between the motivational extended reality system 110 and the network(s) 118 via cellular data technologies such as, but not limited to, General Packet Radio Service (“GPRS”), Enhanced Data rates for Global Evolution (“EDGE”), the High-Speed Packet Access (“HSPA”) protocol family including High-Speed Downlink Packet Access (“HSDPA”), Enhanced Uplink (“EUL”) or otherwise termed High-Speed Uplink Packet Access (“HSUPA”), Evolved HSPA (“HSPA+”), LTE, and/or various other current and future wireless data access technologies. It should be understood that the network(s) 118 may additionally include infrastructure that operates on wired communications technologies, including, but not limited to, optical fiber, coaxial cable, twisted pair cable, and the like to transfer data between various systems operating on or in communication with the network(s) 118, such as the motivational extended reality system 110, the social media platform(s) 112, the application server(s) 114, and the other device(s) 116. An illustrative example of the network(s) 118 is illustrated and described herein with reference to FIG. 4.

The motivational extended reality system 110 can receive one or more inputs 120. In the illustrated example, the inputs 120 include Internet of Things (“IoT”) data 122 obtained from one or more IoT devices 124, personal data 126 obtained from one or more personal data source applications 128, and wearable device data 130 obtained from one or more wearable devices 132 executing one or more wearable device applications 134. Additional and/or alternative inputs are contemplated. The inputs 120 are shown separate from the motivational extended reality system 110, but in some embodiments, one or more of the inputs 120 can be internal to the motivational extended reality system 110. For example, the personal data source applications 128 may be executed by the motivational extended reality system 110 or another device (e.g., a smartphone if different from the motivational extended reality system 110).

The IoT is a concept of making physical objects, collectively “things,” also referred to herein as the IoT devices 124, network addressable to facilitate interconnectivity for the exchange of data, shown as the IoT data 122. The IoT devices 124 can be or can include any “thing” that can collect the IoT data 122 and that is configured to be network addressable so as to connect to and communicate with each other, the motivational extended reality system 110, and/or the other device(s) 116 directly and/or via the network(s) 118. The IoT devices 124 can be deployed for consumer use and/or business use, and can find application in many industry-specific use cases. For example, the IoT devices 124 may find at least partial application in the following industries: automotive, energy, healthcare, industrial, retail, and smart buildings/homes. Those skilled in the art will appreciate the applicability of IoT-solutions in other industries as well as consumer and business use cases.

For purposes of describing some example use cases of the concepts and technologies disclosed herein, the IoT devices 124 will be described as user-centric IoT devices that collect the IoT data 122 about the user 102. For example, the IoT devices 124 may be voice controllers (e.g., AMAZON ALEXA, APPLE SIRI, GOOGLE HOME), smart home devices (e.g., thermostat, security system, light controllers, cameras, air quality monitors, etc.), personal health devices (e.g., smart scales and health monitors), and the like. The IoT devices 124 can collect the IoT data 122 and share the IoT data 122 with the motivational extended reality system 110. Other IoT data 122 can include, but is not limited to, sensor data associated with weather, temperature, air quality, location, and the like.

The personal data source applications 128 can be any applications that collect, generate, or otherwise acquire the personal data 126 about the user 102. The personal data source applications 128 can be executed by the motivational extended reality system 110 and/or one or more of the other device(s) 116. The personal data source applications 128 can include, but are not limited to, one or more calendar applications, one or more fitness applications, one or more health applications, one or more mental health applications, one or more journaling, one or more video game applications, one or more social media applications, and one or more dating applications. In some embodiments, the personal data source application(s) 128 can be configured to interact with one or more of the IoT devices 124 and/or one or more of the wearable devices 132 (directly or via the wearable device application(s) 134 executed by the wearable device(s) 132).

The wearable devices 132 can be any device that is wearable by the user 102 and that can collect, generate, or otherwise acquire the wearable device data 130. Generally, the wearable devices 132 can utilize one or more sensors to collect the wearable device data 130. For example, the wearable devices 132 can include a smart watch, a health monitor (e.g., blood pressure monitor, pulse oximeter, electrocardiogram, heartbeat monitor, and the like), smart glasses, fitness monitors, and the like. In some embodiments, the wearable device data 130 includes raw data obtained from the sensor(s) used by the wearable device(s) 132. In some other embodiments, the wearable device application(s) 134 can format the raw data for export to the motivational extended reality system 110.

The illustrated motivational extended reality system 110 includes an “idealized” identity token (“ID token”) module 136 that can be used create and assign an ID token 138 to the user 102. The ID token 138 can include one or more numbers, one or more letters, one or more symbols, or any combination thereof. The ID token module 136 may generate the ID tokens 138 sequentially (e.g., 1, 2, 3, and so on), randomly, pseudo-randomly, or based on some other methodology.

The ID token 138 can be used to associate the user 102 with the goal(s) 104, the idealized image 106 (or multiple idealized images 106 as the case may be), the IoT data 122, the personal data 126, and the wearable device data 130 for storage in a data store 140. In some embodiments, the data store 140 is or includes a memory device such as a solid state memory device or hard drive. In some other embodiments, the data store 140 is or includes a subscriber identity module (“SIM”) or similar device. The data store 140 may use a combination of memory/storage technologies. The data store 140 may include a file system, a database management system, and/or other data storage construct. Although the data store 140 is shown locally stored on the motivational extended reality system 110, the data store 140 may additionally or alternatively be stored elsewhere, such as on the social media platform(s) 112, the application server(s) 114, and/or the other device(s) 116.

In some embodiments, the motivational extended reality system 110 can share the ID token(s) 138 with other system/devices/platforms, such as the motivational extended reality display 108, the social media platform(s) 112, the application server(s) 114, and/or the other device(s) 116, that, in turn, can access the data store 140 to obtain the idealized image 106 or instructions for how to recreate the idealized image 106 (e.g., metadata about image editing settings). In some embodiments, the ID token(s) 138 can be detected by other nearby devices, such as the motivational extended reality display 108 and/or the other device(s) 116. For example, the motivational extended reality system 110 may broadcast the ID token(s) 138 over BLUETOOTH or other wireless technology such that the other nearby devices that are within range of the BLUETOOTH or other wireless technology signal can receive the ID token(s) 138. Security protocols can be used to ensure that the ID token(s) 138 are not distributed to errant devices.

The motivational extended reality system 110 can include one or more extended reality hardware components 142, which can be built-in, external to, or a combination of built-in and external components. The extended reality hardware components 142 can include, for example, one or more displays (which may include the motivational extended reality display 108 and/or other displays), one or more communications components, one or more processing components, one or more memory components, and one or more camera components.

The communications component(s) can facilitate communications between the motivational extended reality system 110 and the network(s) 118. The communications component(s) can enable short-range communications such as BLUETOOTH, near-field communications, infrared, and the like.

The processing component(s) can include a central processing unit (“CPU”) configured to process data, execute computer-executable instructions of one or more application programs, and communicate with other components of the motivational extended reality system 110 in order to perform various functionality described herein. The processing component(s) can execute instructions of software components such as the ID token module 136, a user interface module 144, an extended reality module 146, and a machine learning module 148. In some embodiments, the processing component(s) can include a graphics processing unit (“GPU”) configured to accelerate operations performed by the CPU, including, but not limited to, operations performed by executing the extended reality module 146 (e.g., to support augmented reality, virtual reality, mixed reality, and/or other immersive technologies), general-purpose scientific and engineering computing applications, as well as graphics-intensive computing applications such as high resolution video (e.g., 480i/p, 720i/p, 1080i/p, 4K, 8K, and greater resolutions), video games (e.g., as one or more of the personal data source applications 128), three-dimensional modeling applications, and the like. In some embodiments, the processing component(s) can communicate with one or more discrete GPU. In any case, the CPU and GPU can be configured in accordance with a co-processing CPU/GPU computing model, wherein the sequential part of an application executes on the CPU and the computationally-intensive part, such as the generation and presentation of augmented reality objects, virtual images, the idealized image 160, and/or the like is accelerated by the GPU. The processing component(s) can be or can be included in a system-on-chip (“SoC”) along with one or more of the other components of the extended reality hardware components 142. For example, the SoC can include the processing component(s), the memory component(s), and the communications component(s). In some embodiments, the processing component(s) can be fabricated, in part, utilizing a package-on-package (“PoP”) integrated circuit packaging technique. Moreover, the processing component(s) can be based on a single core or multi-core architecture.

The processing component(s) can be created in accordance with an ARM architecture, available for license from ARM HOLDINGS of Cambridge, United Kingdom. Alternatively, the processing component(s) can be created in accordance with an x86 architecture, such as is available from INTEL CORPORATION of Mountain View, Calif. and others. In some embodiments, the processing component(s) can be a SNAPDRAGON SoC, available from QUALCOMM of San Diego, Calif., a TEGRA SoC, available from NVIDIA of Santa Clara, Calif., a HUMMINGBIRD SoC, available from SAMSUNG of Seoul, South Korea, an Open Multimedia Application Platform (“OMAP”) SoC, available from TEXAS INSTRUMENTS of Dallas, Tex., a customized version of any of the above SoCs, or a proprietary SoC. The memory component(s) can include random access memory (“RAM”), read-only memory (“ROM”), integrated storage memory, removable storage memory, or any combination thereof. In some embodiments, at least a portion of the memory component(s) can be integrated with the processing component(s). In some embodiments, the memory component(s) can be configured to store a firmware, an operating system or a portion thereof (e.g., operating system kernel), one or more applications (e.g., the personal data source applications 128) other software (e.g., the ID token module 136, the user interface module 144, the extended reality module 146, and/or the machine learning module 148), the goal(s) 104, the idealized image 106, the IoT data 122, the personal data 126, the wearable device data 130, and/or a bootloader to load an operating system kernel.

The memory component(s) can be or can include integrated storage memory such as a solid-state memory, a hard disk, or a combination of solid-state memory and a hard disk. The integrated storage memory can be soldered or otherwise connected to a logic board upon which the processing component(s) and other components described herein also may be connected. The integrated storage memory can store an operating system or portions thereof, application programs, data, and other software components described herein. Removable storage memory can include a solid-state memory, a hard disk, or a combination of solid-state memory and a hard disk. In some embodiments, the removable storage memory is provided in lieu of the integrated storage memory. In other embodiments, the removable storage memory is provided as additional optional storage. In some embodiments, the removable storage memory is logically combined with the integrated storage memory such that the total available storage is made available and shown to a user as a total combined capacity. The removable storage memory can be inserted into a removable storage memory slot (not shown) or other mechanism by which the removable storage memory is inserted and secured to facilitate a connection over which the removable storage memory can communicate with other components of the motivational extended reality system 110, such as the processing component(s). The removable storage memory can be embodied in various memory card formats including, but not limited to, PC card, CompactFlash card, memory stick, secure digital (“SD”), miniSD, microSD, universal integrated circuit card (“UICC”) (e.g., a SIM or universal SIM (“USIM”)), a proprietary format, or the like. As a UICC, the memory component can be part of the communications component. It should be understood that the memory component(s) can store an operating system. According to various embodiments, the operating system includes, but is not limited to, LINUX, SYMBIAN OS from SYMBIAN LIMITED, WINDOWS MOBILE OS from Microsoft Corporation of Redmond, Wash., WINDOWS PHONE OS from Microsoft Corporation, WINDOWS from Microsoft Corporation, PALM WEBOS from Hewlett-Packard Company of Palo Alto, Calif., BLACKBERRY OS from Research In Motion Limited of Waterloo, Ontario, Canada, IOS from Apple Inc. of Cupertino, Calif., and ANDROID OS from Google Inc. of Mountain View, Calif. Other operating systems are contemplated.

The camera component(s) can be or can include one or more image sensors used to capture still images and live video. The image sensor(s) can utilize charge coupled device (“CCD”), complementary metal oxide semiconductor (“CMOS”), and/or other image sensor technology. In some embodiments, the camera component(s) include additional sensors, such as light sensor, light detection and ranging (“LiDAR”) sensor, motion sensor, gyroscope, combinations thereof, and/or the like, to enable additional capabilities of the image sensor(s). The idealized image 106 can be a standalone image or can be part of the still image(s) and/or live video captured by the camera component(s).

The user interface module 144 can provide a graphical user interface through which the user 102 can interact with the motivational extended reality system 110. For example, the user 102 can configure the inputs 120, define the goal(s) 104, define the idealized image 106, and/or perform other interactions with the motivational extended reality system 110.

The extended reality module 146 can include extended reality software that enables the motivational extended reality system 110 to create and present extended reality objects to the user 102, such as via the motivational extended reality display 108. In some embodiments, the extended reality module 146 is or includes an augmented reality toolkit such as ARKit (available from Apple Inc.), a virtual reality toolkit such as VRTK (open source), and/or a mixed reality toolkit such as MRTK (open source). The extended reality module 146 can determine which one or more physical objects that can be used as an augmented reality object anchor to which augmented reality object can be associated as part of an augmented reality overlay generated by the extended reality module 146 and presented via the motivational extended reality display 108 over a live video image. This determination can be made based upon content type, size, shape, color, or any other physical characteristic of the physical object(s).

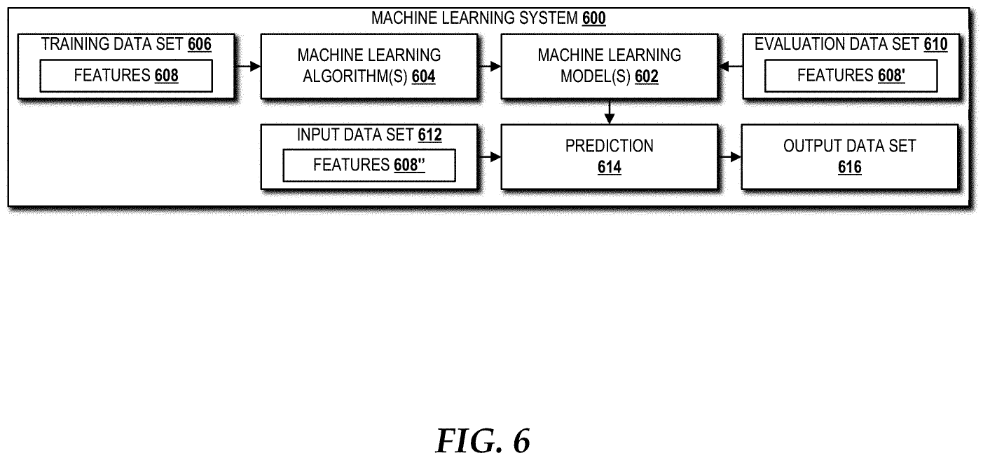

The machine learning module 148 can be used in support of various aspects disclosed herein, such as processing input data, creating the idealized image 106, and/or performing other operations disclosed herein. The machine learning module 148 can be configured to perform machine learning operations locally on the motivational extended reality system 110 or interact with a remote machine learning system such as the machine learning system illustrated and described herein with reference to FIG. 6.

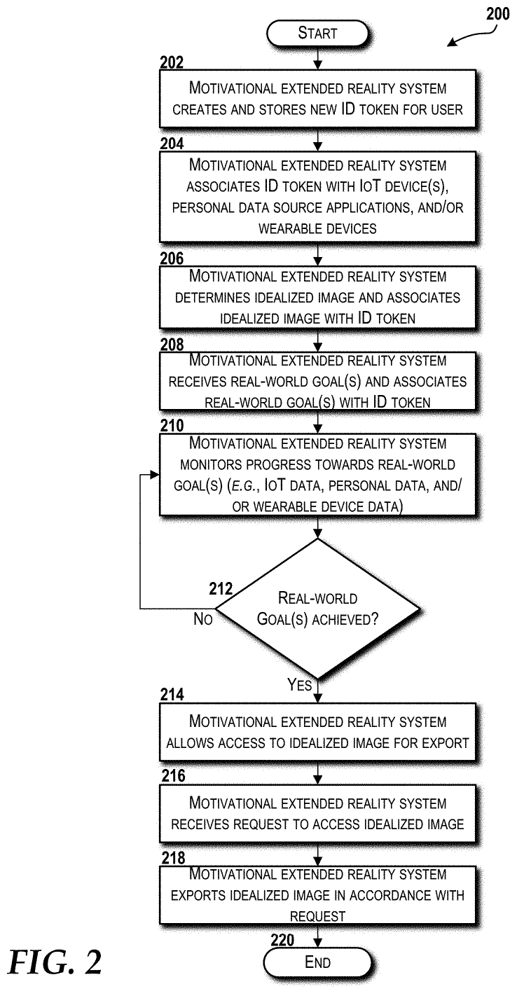

Turning now to FIG. 2, a flow diagram illustrating aspects of a method 200 for implementing motivational extended reality will be described, according to an illustrative embodiment. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the concepts and technologies disclosed herein.

It also should be understood that the methods disclosed herein can be ended at any time and need not be performed in its entirety. Some or all operations of the methods, and/or substantially equivalent operations, can be performed by execution of computer-readable instructions included on a computer storage media, as defined herein. The term “computer-readable instructions,” and variants thereof, as used herein, is used expansively to include routines, applications, application modules, program modules, programs, components, data structures, algorithms, and the like. Computer-readable instructions can be implemented on various system configurations including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These states, operations, structural devices, acts, and modules may be implemented in software, in firmware, in special purpose digital logic, and any combination thereof. As used herein, the phrase “cause a processor to perform operations” and variants thereof is used to refer to causing a processor of a computing system or device, such as, for example, the motivational extended reality system 110, to perform one or more operations, and/or causing the processor to direct other components of the computing system or device to perform one or more of the operations.

For purposes of illustrating and describing the concepts of the present disclosure, operations of the methods disclosed herein are described as being performed by alone or in combination via execution of one or more software modules, and/or other software/firmware components described herein. It should be understood that additional and/or alternative devices and/or network nodes can provide the functionality described herein via execution of one or more modules, applications, and/or other software. Thus, the illustrated embodiments are illustrative, and should not be viewed as being limiting in any way.

The method 200 begins and proceeds to operation 202. At operation 202, the motivational extended reality system 110 creates and stores a new ID token 138 for the user 102. The ID token 138 can be used to associate the user 102 with the goal(s) 104, the idealized image 106 (or multiple idealized images 106 as the case may be), the IoT data 122, the personal data 126, and the wearable device data 130 for storage in the data store 140. In some embodiments, the motivational extended reality system 110 can present a user interface through which the user 102 can specify the goal(s) 104 and/or the idealized image 106.

From operation 202, the method 200 proceeds to operation 204. At operation 204, the motivational extended reality system 110 can associate the ID token 138 with one or more of the IoT devices 124. In some embodiments, the motivational extended reality system 110 can store, in the data store 140, the ID token 138 in association with an identifier for each of the IoT devices 124 to be used as a source for the IoT data 122. The motivational extended reality system 110 can create the identifier(s) based on any combination of letters, numbers, symbols, and/or characters. In addition, the motivational extended reality system 110 can store, in the data store 140, the ID token 138 with a network address, such as, for example, a media access control (“MAC”) address, BLUETOOTH address, IP address, or the like, for each of the IoT devices 124 to be used as a source for the IoT data 122. In this manner, the motivational extended reality system 110 can store the IoT data 122 received from the IoT device(s) 124 in association with the ID token 138. The motivational extended reality system 110 also can associate the ID token 138 with a user account for each of the personal data source applications 128 to be used as an input data source. Similarly, the motivational extended reality system 110 also can associate the ID token 138 with a user account of the wearable device application 134 and/or a network address of the wearable device 132.

From operation 204, the method 200 proceeds to operation 206. At operation 206, the motivational extended reality system 110 determines the idealized image 106 and associates the idealized image 106 with the ID token 138. It is contemplated that the user 102 may have one ID token 138 for multiple idealized images 106 or multiple ID tokens 138 each being associated with one idealized image 106. For ease of explanation, a single idealized image 106 will be used as an example.

The motivational extended reality system 110 can determine the idealized image 106 in multiple ways. In some embodiments, the motivational extended reality system 110 prompts the user 102, via the user interface module 144, to obtain a baseline image. The user interface module 144 may use text, other images (e.g., overlay), extended reality, audio, video, or some combination thereof to instruct the user 102 how to take the baseline image. The baseline image may be obtained using a camera component of the extended reality hardware components 142, a camera component of one of the IoT devices 124, or a camera component of one of the wearable devices 132. Alternatively, the user 102 may elect to use an image taken in the past. For example, in embodiments in which the motivational extended reality system 110 is embodied as a smartphone, the user 102 may be instructed to select an image from a photo library that is stored in the data store 140 or elsewhere on a storage component of the motivational extended reality system 110. The user 102 may alternatively instruct the motivational extended reality system 110 to obtain the image from an external source, such as, for example, one of the social media platform(s) 112, the application server(s) 114, or the other device(s) 116. The user interface module 144 (or similar if taken by a system/device other than the motivational extended reality system 110) may guide the user 102 to take the baseline image. The user interface module 144 may then provide the user 102 with filters and/or other image adjustment tools to enable the user 102 to define the idealized image 106. In some embodiments, the motivational extended reality system 110 may call one or more application programming interfaces (not shown) of a photography and/or other image processing applications to enable the filters and/or other image adjustment tools. Alternatively, the motivational extended reality system 110 may provide the filters and/or other image adjustment tools natively. The user 102 may define the idealized image 106 by using the filters and/or other image adjustment tools to adjust one or more aspects of their appearance in the baseline image. For example, the user 102 may change the size, shape, or color of any part of the baseline image to reflect how they would like themselves to be perceived (i.e., an idealized image of themselves). In some embodiments, the idealized image 106 is used as defined. In other embodiments, metadata associated with the changes made by the user 102 can be used as a template to modify images for presentation on the motivational extended reality display 108 as the idealized image 106. In some embodiments, the changes can be implemented in an augmented reality overlay such that when superimposed on top of another image of the user 102, the user 102 appears as desired in the form of the idealized image 106.

From operation 206, the method 200 proceeds to operation 208. At operation 208, the motivational extended reality system 110 receives the goal(s) 104 specified by the user 102 and associates the goal(s) 104 with the ID token 138 and the idealized image 106 in the data store 140. The user 102 can specify the goal(s) 104 directly via the user interface module 144 of the motivational extended reality system 110. Alternatively, the goal(s) 104 can be obtained from the IoT device(s) 124, the personal data source application(s) 128, the wearable device(s) 132, the social media platform(s) 112, the application server(s) 114, the other device(s), or some combination thereof. The goal(s) 104 alternatively or additionally can be established for the user 102 by one or more entities such as, for example, another person, an application, a company, or a service. The goal(s) 104 can be anything the user 102 desires to achieve. By way of example, and not limitation, the goal(s) 104 may be related to the health of the user 102, such as a target weight of the user 102, one or more target measurements of the user 102 (e.g., waist size, chest size, shoulder size, arm size, or leg size), a target caloric intake of the user 102, a target diet of the user 102, combinations thereof, and/or the like. The goal(s) 104 may be related to other aspects of the user 102 and/or the user's 102 life. For example, the goal(s) 104 may be to achieve a career goal, an education goal, or some other life goal. The goal(s) 104 may be directly associated with an aspect of the idealized image 106. For example, a goal 104 for the user 102 may be to lose 20 pounds and the idealized image 106 may depict what the user 102 thinks they will look like after losing 20 pounds. The goals(s) may be indirectly associated with an aspect of the idealized image 106. For example, a goal 104 may be for the user 102 to make Dean's List at their college and the idealized image 106 may still depict what the user 102 thinks they will look like after losing 20 pounds. In other words, the idealized image 106 can be provided as a motivational tool for the user 102 to achieve the goal(s) 104 even if the goal(s) 104 are not directly associated with the idealized image 106. For purposes of describing the remaining operations of the method 200, a single goal 104 will be referenced. It should be understood, however, that multiple goals 104, including tiered goals, are contemplated.

From operation 208, the method 200 proceeds to operation 210. At operation 210, the motivational extended reality system 110 monitors the user's 102 progress towards meeting the goal 104. The motivational extended reality system 110 can monitor the user's 102 progress based upon the IoT data 122, the personal data 126, and/or the wearable device data 130. Borrowing the example above, if the goal 104 of the user 102 is to lose 20 pounds, the IoT data 122 can include the user's 102 weight as measured by an IoT scale. The personal data 126 may include the user's 102 weight as recorded by one or more of the personal data source applications 128 (e.g., a fitness or health application). The wearable device data 130 may include an estimated calories burned calculated by the wearable device application(s) 134. This data alone or in combination with other data may be used to estimate the user's 102 progress towards losing 20 pounds. Those skilled in the art will appreciate the numerous combinations of the IoT data 122, the personal data 126, and the wearable device data 130 that can be used to determine the user's 102 progress towards meeting the goal 104.

From operation 210, the method 200 proceeds to operation 212. At operation 212, the motivational extended reality system 110 analyzes the IoT data 122, the personal data 126, and/or the wearable device data 130 to determine if the goal 104 has been achieved. If the motivational extended reality system 110 determines that the goal(s) 104 have not be achieved, the method 200 returns to operation 210, where the motivational extended reality system 110 continues to analyze the IoT data 122, the personal data 126, and/or the wearable device data 130 to determine if the goal 104 has been achieved. If, at operation 212, the motivational extended reality system 110 determines that the goal 104 has been achieved, the method 200 proceeds to operation 214.

At operation 214, the motivational extended reality system 110 allows access to the idealized image 106 for export. From operation 214, the method 200 proceeds to operation 216. At operation 216, the motivational extended reality system 110 receives a request to access the idealized image 106. The request can be made internally. For example, the extended reality module 146 may request the idealized image 106 from the data store 140. The request can be made externally, such as from one of the IoT devices 124, one of the personal data source applications 128, one of the wearable devices 132, the motivational extended reality display 108, one of the social media platforms 112, one of the application servers 114, or one of the other devices 116.

From operation 216, the method 200 proceeds to operation 218. At operation 218, the motivational extended reality system can export the idealized image 106 in accordance with the request.

From operation 218, the method 200 proceeds to operation 220. The method 200 can end at operation 220.

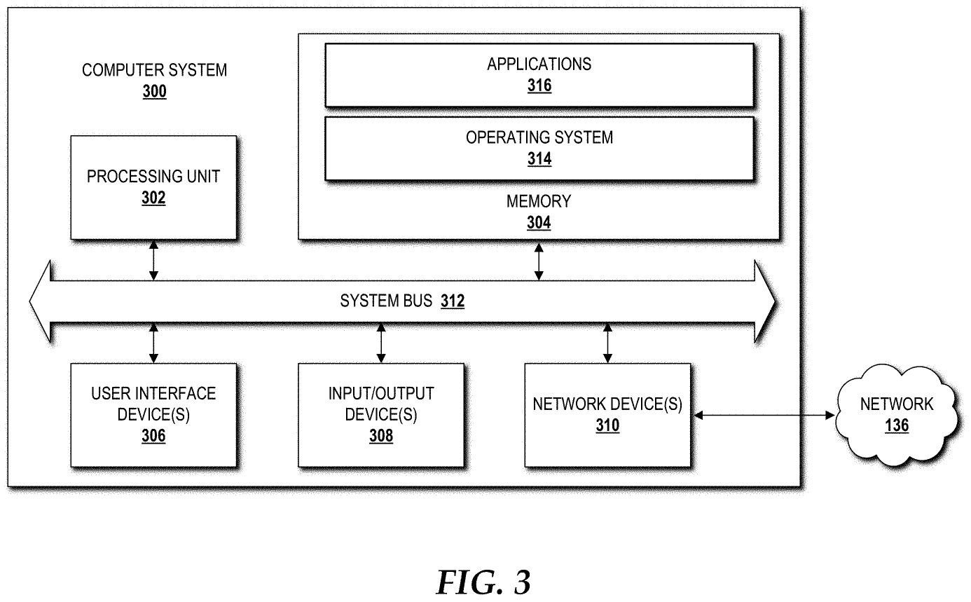

Turning now to FIG. 3, a block diagram illustrating a computer system 300 configured to provide the functionality described herein in accordance with various embodiments of the concepts and technologies disclosed herein will be described. In some embodiments, the motivational extended reality system 110, one or more of the IoT devices 124, one or more of the wearable devices 132, one or more of the other devices 116, one or more components thereof, and/or other systems/platforms/devices/elements disclosed herein can be configured like and/or can have an architecture similar or identical to the computer system 300 described herein with respect to FIG. 3. It should be understood, however, that any of these systems, devices, platforms, or elements may or may not include the functionality described herein with reference to FIG. 3.

The computer system 300 includes a processing unit 302, a memory 304, one or more user interface devices 306, one or more input/output (“I/O”) devices 308, and one or more network devices 310, each of which is operatively connected to a system bus 312. The bus 312 enables bi-directional communication between the processing unit 302, the memory 304, the user interface devices 306, the I/O devices 308, and the network devices 310.

The processing unit 302 may be a standard central processor that performs arithmetic and logical operations, a more specific purpose programmable logic controller (“PLC”), a programmable gate array, or other type of processor known to those skilled in the art and suitable for controlling the operation of the computer system 300.

The memory 304 communicates with the processing unit 302 via the system bus 312. In some embodiments, the memory 304 is operatively connected to a memory controller (not shown) that enables communication with the processing unit 302 via the system bus 312. The memory 304 includes an operating system 314 and one or more program modules 316. The operating system 314 can include, but is not limited to, members of the WINDOWS, WINDOWS CE, and/or WINDOWS MOBILE families of operating systems from MICROSOFT CORPORATION, the LINUX family of operating systems, the SYMBIAN family of operating systems from SYMBIAN LIMITED, the BREW family of operating systems from QUALCOMM CORPORATION, the MAC OS, and/or iOS families of operating systems from APPLE CORPORATION, the FREEBSD family of operating systems, the SOLARIS family of operating systems from ORACLE CORPORATION, other operating systems, and the like.

The program modules 316 can include various software, program modules, and/or data described herein. For example, the program modules 316 can include the personal data source applications 128, the wearable device applications 134, the ID token module 136, the user interface module 144, the extended reality module 146, and/or the machine learning module 148. The memory 304 also can store the ID token(s) 138, the data store 140, the IoT data 122, the goal(s) 104, the personal data 126, the idealized image(s) 106, the wearable device data 130, and/or other data described herein.

By way of example, and not limitation, computer-readable media may include any available computer storage media or communication media that can be accessed by the computer system 300. Communication media includes computer-readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, radio frequency, infrared and other wireless media. Combinations of the any of the above should also be included within the scope of computer-readable media.

Computer storage media includes volatile and non-volatile, removable and non-removable media implemented in any method or technology for storage of information such as computer-readable instructions, data structures, program modules, or other data. Computer storage media includes, but is not limited to, RAM, ROM, Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer system 300. In the claims, the phrase “computer storage medium,” “computer-readable storage medium,” and variations thereof does not include waves or signals per se and/or communication media, and therefore should be construed as being directed to “non-transitory” media only.

The user interface devices 306 may include one or more devices with which a user accesses the computer system 300. The user interface devices 306 may include, but are not limited to, computers, servers, personal digital assistants, cellular phones, or any suitable computing devices. The I/O devices 308 enable a user to interface with the program modules 316. In one embodiment, the I/O devices 308 are operatively connected to an I/O controller (not shown) that enables communication with the processing unit 302 via the system bus 312. The I/O devices 308 may include one or more input devices, such as, but not limited to, a keyboard, a mouse, or an electronic stylus. Further, the I/O devices 308 may include one or more output devices, such as, but not limited to, a display screen or a printer to output data.

The network devices 310 enable the computer system 300 to communicate with other networks or remote systems via one or more networks, such as the network(s) 120 (best shown in FIGS. 1 and 4). Examples of the network devices 310 include, but are not limited to, a modem, a RF or infrared (“IR”) transceiver, a telephonic interface, a bridge, a router, or a network card. The network(s) may include a wireless network such as, but not limited to, a WLAN such as a WI-FI network, a WWAN, a Wireless Personal Area Network (“WPAN”) such as BLUETOOTH, a Wireless Metropolitan Area Network (“WMAN”) such as a Worldwide Interoperability for Microwave Access (“WiMAX”) network, or a cellular network. Alternatively, the network(s) may be a wired network such as, but not limited to, a WAN such as the Internet, a LAN, a wired PAN, or a wired MAN.

Turning now to FIG. 4, additional details of an embodiment of the network 118 will be described, according to an illustrative embodiment. In the illustrated embodiment, the network 118 includes a cellular network 402, a packet data network 404, for example, the Internet, and a circuit switched network 406, for example, a publicly switched telephone network (“PSTN”). The cellular network 402 includes various components such as, but not limited to, base transceiver stations (“BTSs”), Node-B's or e-Node-B's, base station controllers (“BSCs”), radio network controllers (“RNCs”), mobile switching centers (“MSCs”), mobile management entities (“MMEs”), short message service centers (“SMSCs”), multimedia messaging service centers (“MMSCs”), home location registers (“HLRs”), HSSs, visitor location registers (“VLRs”), charging platforms, billing platforms, voicemail platforms, GPRS core network components, location service nodes, an IP Multimedia Subsystem (“IMS”), and the like. The cellular network 402 also includes radios and nodes for receiving and transmitting voice, data, and combinations thereof to and from radio transceivers, networks, the packet data network 404, and the circuit switched network 406.

A mobile communications device 408, such as, for example, a cellular telephone, a user equipment, a mobile terminal, a PDA, a laptop computer, a handheld computer, and combinations thereof, can be operatively connected to the cellular network 402. In some embodiments, the mobile communications device 408 can be or can include the motivational extended reality system 110. The cellular network 402 can be configured to utilize any using any wireless communications technology or combination of wireless communications technologies, some examples of which include, but are not limited to, GSM, CDMA ONE, CDMA2000, UMTS, LTE, WiMAX), other IEEE 802.XX technologies, mmWave, and the like. The mobile communications device 408 can communicate with the cellular network 402 via various channel access methods (which may or may not be used by the aforementioned technologies), including, but not limited to, TDMA, FDMA, CDMA, W-CDMA, OFDM, SC-FDMA, SDMA, and the like. Data can be exchanged between the mobile communications device 408 and the cellular network 402 via cellular data technologies such as, but not limited to, GPRS, EDGE, the HSPA protocol family including HSDPA, EUL or otherwise termed HSUPA, HSPA+, LTE, 5G technologies, and/or various other current and future wireless data access technologies. It should be understood that the cellular network 402 may additionally include backbone infrastructure that operates on wired communications technologies, including, but not limited to, optical fiber, coaxial cable, twisted pair cable, and the like to transfer data between various systems operating on or in communication with the cellular network 402.

The packet data network 404 can include various systems/platforms/devices, such as, for example, the motivational extended reality system 110, the motivational extended reality display 108, the IoT device(s) 124, the wearable device(s) 132, the social media platform(s) 112, the application server(s) 114, the other device(s) 116, servers, computers, databases, and other systems/platforms/devices, in communication with one another. The packet data network 404 devices are accessible via one or more network links. The servers often store various files that are provided to a requesting device such as, for example, a computer, a terminal, a smartphone, or the like. Typically, the requesting device includes software (a “browser”) for executing a web page in a format readable by the browser or other software. Other files and/or data may be accessible via “links” in the retrieved files, as is generally known. In some embodiments, the packet data network 404 includes or is in communication with the Internet.

The circuit switched network 406 includes various hardware and software for providing circuit switched communications. The circuit switched network 406 may include, or may be, what is often referred to as a plain old telephone system (“POTS”). The functionality of a circuit switched network 406 or other circuit-switched network are generally known and will not be described herein in detail.

The illustrated cellular network 402 is shown in communication with the packet data network 404 and a circuit switched network 406, though it should be appreciated that this is not necessarily the case. One or more Internet-capable systems/devices 410, for example, the motivational extended reality system 110, the motivational extended reality display 108, the IoT device(s) 124, the wearable device(s) 132, the social media platform(s) 112, the application server(s) 114, the other device(s) 116, a personal computer (“PC”), a laptop, a portable device, or another suitable device, can communicate with one or more cellular networks 402, and devices connected thereto, through the packet data network 404. It also should be appreciated that the Internet-capable device 410 can communicate with the packet data network 404 through the circuit switched network 406, the cellular network 402, and/or via other networks (not illustrated).

As illustrated, a communications device 412, for example, a telephone, facsimile machine, modem, computer, or the like, can be in communication with the circuit switched network 406, and therethrough to the packet data network 404 and/or the cellular network 402. It should be appreciated that the communications device 412 can be an Internet-capable device, and can be substantially similar to the Internet-capable device 410. It should be appreciated that substantially all of the functionality described with reference to the network 118 can be performed by the cellular network 402, the packet data network 404, and/or the circuit switched network 406, alone or in combination with additional and/or alternative networks, network elements, and the like.

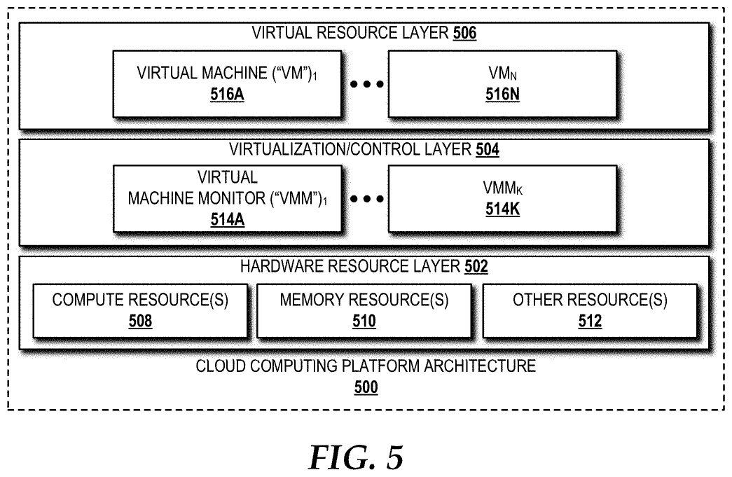

Turning now to FIG. 5, a cloud computing platform architecture 500 capable of implementing aspects of the concepts and technologies disclosed herein will be described, according to an illustrative embodiment. In some embodiments, the motivational extended reality system 110, the social media platform(s) 112, the application server(s) 114, and/or the other device(s) 116 can be implemented, at least in part, on the cloud computing platform architecture 500. Those skilled in the art will appreciate that the illustrated cloud computing platform architecture 500 is a simplification of but one possible implementation of an illustrative cloud computing platform, and as such, the cloud computing platform architecture 500 should not be construed as limiting in any way.

The illustrated cloud computing platform architecture 500 includes a hardware resource layer 502, a virtualization/control layer 504, and a virtual resource layer 506 that work together to perform operations as will be described in detail herein. While connections are shown between some of the components illustrated in FIG. 5, it should be understood that some, none, or all of the components illustrated in FIG. 5 can be configured to interact with one other to carry out various functions described herein. In some embodiments, the components are arranged so as to communicate via one or more networks (not shown). Thus, it should be understood that FIG. 5 and the following description are intended to provide a general understanding of a suitable environment in which various aspects of embodiments can be implemented, and should not be construed as being limiting in any way.

The hardware resource layer 502 provides hardware resources, which, in the illustrated embodiment, include one or more compute resources 508, one or more memory resources 510, and one or more other resources 512. The compute resource(s) 506 can include one or more hardware components that perform computations to process data, and/or to execute computer-executable instructions of one or more application programs, operating systems, and/or other software. The compute resources 508 can include one or more central processing units (“CPUs”) configured with one or more processing cores. The compute resources 508 can include one or more graphics processing unit (“GPU”) configured to accelerate operations performed by one or more CPUs, and/or to perform computations to process data, and/or to execute computer-executable instructions of one or more application programs, operating systems, and/or other software that may or may not include instructions particular to graphics computations. In some embodiments, the compute resources 508 can include one or more discrete GPUs. In some other embodiments, the compute resources 508 can include CPU and GPU components that are configured in accordance with a co-processing CPU/GPU computing model, wherein the sequential part of an application executes on the CPU and the computationally-intensive part is accelerated by the GPU. The compute resources 508 can include one or more system-on-chip (“SoC”) components along with one or more other components, including, for example, one or more of the memory resources 510, and/or one or more of the other resources 512. In some embodiments, the compute resources 508 can be or can include one or more SNAPDRAGON SoCs, available from QUALCOMM of San Diego, Calif.; one or more TEGRA SoCs, available from NVIDIA of Santa Clara, Calif.; one or more HUMMINGBIRD SoCs, available from SAMSUNG of Seoul, South Korea; one or more Open Multimedia Application Platform (“OMAP”) SoCs, available from TEXAS INSTRUMENTS of Dallas, Tex.; one or more customized versions of any of the above SoCs; and/or one or more proprietary SoCs. The compute resources 508 can be or can include one or more hardware components architected in accordance with an ARM architecture, available for license from ARM HOLDINGS of Cambridge, United Kingdom. Alternatively, the compute resources 508 can be or can include one or more hardware components architected in accordance with an x86 architecture, such an architecture available from INTEL CORPORATION of Mountain View, Calif., and others. Those skilled in the art will appreciate the implementation of the compute resources 508 can utilize various computation architectures, and as such, the compute resources 508 should not be construed as being limited to any particular computation architecture or combination of computation architectures, including those explicitly disclosed herein.

The memory resource(s) 510 can include one or more hardware components that perform storage operations, including temporary or permanent storage operations. In some embodiments, the memory resource(s) 510 include volatile and/or non-volatile memory implemented in any method or technology for storage of information such as computer-readable instructions, data structures, program modules, or other data disclosed herein. Computer storage media includes, but is not limited to, random access memory (“RAM”), read-only memory (“ROM”), Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store data and which can be accessed by the compute resources 508.

The other resource(s) 512 can include any other hardware resources that can be utilized by the compute resources(s) 506 and/or the memory resource(s) 510 to perform operations. The other resource(s) 512 can include one or more input and/or output processors (e.g., network interface controller or wireless radio), one or more modems, one or more codec chipset, one or more pipeline processors, one or more fast Fourier transform (“FFT”) processors, one or more digital signal processors (“DSPs”), one or more speech synthesizers, and/or the like.

The hardware resources operating within the hardware resource layer 502 can be virtualized by one or more virtual machine monitors (“VMMs”) 514A-514K (also known as “hypervisors”; hereinafter “VMMs 514”) operating within the virtualization/control layer 504 to manage one or more virtual resources that reside in the virtual resource layer 506. The VMMs 514 can be or can include software, firmware, and/or hardware that alone or in combination with other software, firmware, and/or hardware, manages one or more virtual resources operating within the virtual resource layer 506.

The virtual resources operating within the virtual resource layer 506 can include abstractions of at least a portion of the compute resources 508, the memory resources 510, the other resources 512, or any combination thereof. These abstractions are referred to herein as virtual machines (“VMs”). In the illustrated embodiment, the virtual resource layer 506 includes VMs 516A-516N (hereinafter “VMs 516”).

Turning now to FIG. 6, a machine learning system 600 capable of implementing aspects of the embodiments disclosed herein will be described. In some embodiments, the motivational extended reality system 110 can be configured to utilize the machine learning system 600. For example, the motivational extended reality system 110 may use the machine learning module 148 to access the machine learning system 600 to aid in performing operations described herein, such as described above with reference to the method 200. In some other embodiments, the motivational extended reality system 110 includes the machine learning system 600.

The illustrated machine learning system 600 includes one or more machine learning models 602. The machine learning models 602 can include supervised and/or semi-supervised learning models. The machine learning model(s) 602 can be created by the machine learning system 600 based upon one or more machine learning algorithms 604. The machine learning algorithm(s) 604 can be any existing, well-known algorithm, any proprietary algorithms, or any future machine learning algorithm. Some example machine learning algorithms 604 include, but are not limited to, gradient descent, linear regression, logistic regression, linear discriminant analysis, classification tree, regression tree, Naive Bayes, K-nearest neighbor, learning vector quantization, support vector machines, and the like. Classification and regression algorithms might find particular applicability to the concepts and technologies disclosed herein. Those skilled in the art will appreciate the applicability of various machine learning algorithms 604 based upon the problem(s) to be solved by machine learning via the machine learning system 600.

The machine learning system 600 can control the creation of the machine learning models 602 via one or more training parameters. In some embodiments, the training parameters are selected modelers at the direction of an enterprise, for example. Alternatively, in some embodiments, the training parameters are automatically selected based upon data provided in one or more training data sets 606. The training parameters can include, for example, a learning rate, a model size, a number of training passes, data shuffling, regularization, and/or other training parameters known to those skilled in the art.

The learning rate is a training parameter defined by a constant value. The learning rate affects the speed at which the machine learning algorithm 604 converges to the optimal weights. The machine learning algorithm 604 can update the weights for every data example included in the training data set 606. The size of an update is controlled by the learning rate. A learning rate that is too high might prevent the machine learning algorithm 604 from converging to the optimal weights. A learning rate that is too low might result in the machine learning algorithm 604 requiring multiple training passes to converge to the optimal weights.

The model size is regulated by the number of input features (“features”) 606 in the training data set 606. A greater the number of features 608 yields a greater number of possible patterns that can be determined from the training data set 606. The model size should be selected to balance the resources (e.g., compute, memory, storage, etc.) needed for training and the predictive power of the resultant machine learning model 602.

The number of training passes indicates the number of training passes that the machine learning algorithm 604 makes over the training data set 606 during the training process. The number of training passes can be adjusted based, for example, on the size of the training data set 606, with larger training data sets being exposed to fewer training passes in consideration of time and/or resource utilization. The effectiveness of the resultant machine learning model 602 can be increased by multiple training passes.

Data shuffling is a training parameter designed to prevent the machine learning algorithm 604 from reaching false optimal weights due to the order in which data contained in the training data set 606 is processed. For example, data provided in rows and columns might be analyzed first row, second row, third row, etc., and thus an optimal weight might be obtained well before a full range of data has been considered. By data shuffling, the data contained in the training data set 606 can be analyzed more thoroughly and mitigate bias in the resultant machine learning model 602.

Regularization is a training parameter that helps to prevent the machine learning model 602 from memorizing training data from the training data set 606. In other words, the machine learning model 602 fits the training data set 606, but the predictive performance of the machine learning model 602 is not acceptable. Regularization helps the machine learning system 600 avoid this overfitting/memorization problem by adjusting extreme weight values of the features 608. For example, a feature that has a small weight value relative to the weight values of the other features in the training data set 606 can be adjusted to zero.

The machine learning system 600 can determine model accuracy after training by using one or more evaluation data sets 610 containing the same features 608′ as the features 608 in the training data set 606. This also prevents the machine learning model 602 from simply memorizing the data contained in the training data set 606. The number of evaluation passes made by the machine learning system 600 can be regulated by a target model accuracy that, when reached, ends the evaluation process and the machine learning model 602 is considered ready for deployment.

After deployment, the machine learning model 602 can perform a prediction operation (“prediction”) 614 with an input data set 612 having the same features 608″ as the features 608 in the training data set 606 and the features 608′ of the evaluation data set 610. The results of the prediction 614 are included in an output data set 616 consisting of predicted data. The machine learning model 602 can perform other operations, such as regression, classification, and others. As such, the example illustrated in FIG. 6 should not be construed as being limiting in any way.

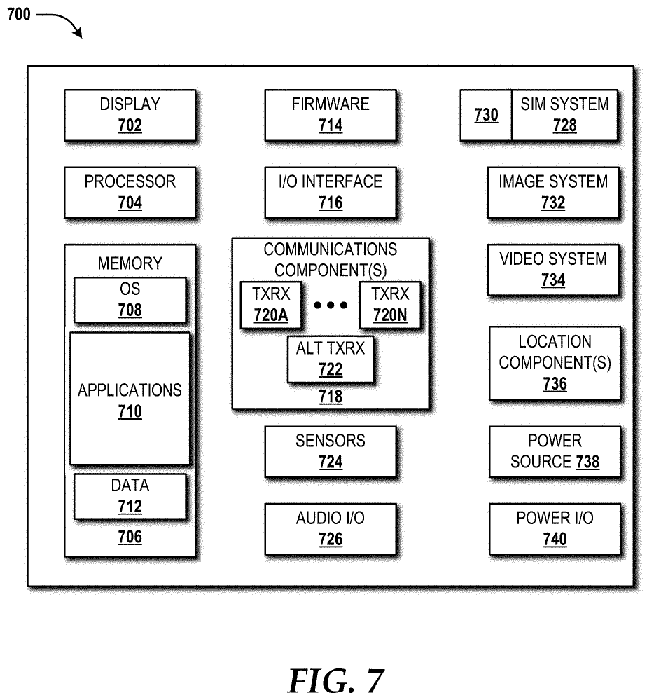

Turning now to FIG. 7, an illustrative mobile device 700 and components thereof will be described. In some embodiments, the motivational extended reality system 110, the IoT device(s) 124, the wearable device(s) 132, and/or the other device(s) 116 is/are configured similar to or the same as the mobile device 700. While connections are not shown between the various components illustrated in FIG. 7, it should be understood that some, none, or all of the components illustrated in FIG. 7 can be configured to interact with one another to carry out various device functions. In some embodiments, the components are arranged so as to communicate via one or more busses (not shown). Thus, it should be understood that FIG. 7 and the following description are intended to provide a general understanding of a suitable environment in which various aspects of embodiments can be implemented, and should not be construed as being limiting in any way.

As illustrated in FIG. 7, the mobile device 700 can include a display 702 for displaying data. According to various embodiments, the display 702 can be configured to display various GUI elements, text, images, video, virtual keypads and/or keyboards, messaging data, notification messages, metadata, Internet content, device status, time, date, calendar data, device preferences, map and location data, combinations thereof, and/or the like. The mobile device 700 also can include a processor 704 and a memory or other data storage device (“memory”) 706. The processor 704 can be configured to process data and/or can execute computer-executable instructions stored in the memory 706. The computer-executable instructions executed by the processor 704 can include, for example, an operating system 708, one or more applications 710 (e.g., the personal data source application(s) 128, the user interface module 144, the extended reality module 146, and/or the machine learning module 148), other computer-executable instructions stored in the memory 706, or the like. In some embodiments, the applications 710 also can include a UI application (not illustrated in FIG. 7).

The UI application can interface with the operating system 708 to facilitate user interaction with functionality and/or data stored at the mobile device 700 and/or stored elsewhere. In some embodiments, the operating system 708 can include a member of the SYMBIAN OS family of operating systems from SYMBIAN LIMITED, a member of the WINDOWS MOBILE OS and/or WINDOWS PHONE OS families of operating systems from MICROSOFT CORPORATION, a member of the PALM WEBOS family of operating systems from HEWLETT PACKARD CORPORATION, a member of the BLACKBERRY OS family of operating systems from RESEARCH IN MOTION LIMITED, a member of the IOS family of operating systems from APPLE INC., a member of the ANDROID OS family of operating systems from GOOGLE INC., and/or other operating systems. These operating systems are merely illustrative of some contemplated operating systems that may be used in accordance with various embodiments of the concepts and technologies described herein and therefore should not be construed as being limiting in any way.

The UI application can be executed by the processor 704 to aid a user in entering/deleting data, entering and setting user IDs and passwords for device access, configuring settings, manipulating content and/or settings, multimode interaction, interacting with other applications 710, and otherwise facilitating user interaction with the operating system 708, the applications 710, and/or other types or instances of data 712 that can be stored at the mobile device 700.

The applications 710, the data 712, and/or portions thereof can be stored in the memory 706 and/or in a firmware 714, and can be executed by the processor 704. The firmware 714 also can store code for execution during device power up and power down operations. It can be appreciated that the firmware 714 can be stored in a volatile or non-volatile data storage device including, but not limited to, the memory 706 and/or a portion thereof.

The mobile device 700 also can include an input/output (“I/O”) interface 716. The I/O interface 716 can be configured to support the input/output of data such as location information, presence status information, user IDs, passwords, and application initiation (start-up) requests. In some embodiments, the I/O interface 716 can include a hardwire connection such as a universal serial bus (“USB”) port, a mini-USB port, a micro-USB port, an audio jack, a PS2 port, an IEEE 1394 (“FIREWIRE”) port, a serial port, a parallel port, an Ethernet (RJ45) port, an RJ11 port, a proprietary port, combinations thereof, or the like. In some embodiments, the mobile device 700 can be configured to synchronize with another device to transfer content to and/or from the mobile device 700. In some embodiments, the mobile device 700 can be configured to receive updates to one or more of the applications 710 via the I/O interface 716, though this is not necessarily the case. In some embodiments, the I/O interface 716 accepts I/O devices such as keyboards, keypads, mice, interface tethers, printers, plotters, external storage, touch/multi-touch screens, touch pads, trackballs, joysticks, microphones, remote control devices, displays, projectors, medical equipment (e.g., stethoscopes, heart monitors, and other health metric monitors), modems, routers, external power sources, docking stations, combinations thereof, and the like. It should be appreciated that the I/O interface 716 may be used for communications between the mobile device 700 and a network device or local device.

The mobile device 700 also can include a communications component 718. The communications component 718 can be configured to interface with the processor 704 to facilitate wired and/or wireless communications with one or more networks, such as the network 118, the Internet, or some combination thereof. In some embodiments, the communications component 718 includes a multimode communications subsystem for facilitating communications via the cellular network and one or more other networks.

The communications component 718, in some embodiments, includes one or more transceivers. The one or more transceivers, if included, can be configured to communicate over the same and/or different wireless technology standards with respect to one another. For example, in some embodiments, one or more of the transceivers of the communications component 718 may be configured to communicate using Global System for Mobile communications (“GSM”), Code-Division Multiple Access (“CDMA”) CDMAONE, CDMA2000, Long-Term Evolution (“LTE”) LTE, and various other 2G, 2.5G, 3G, 4G, 4.5G, 5G, and greater generation technology standards. Moreover, the communications component 718 may facilitate communications over various channel access methods (which may or may not be used by the aforementioned standards) including, but not limited to, Time-Division Multiple Access (“TDMA”), Frequency-Division Multiple Access (“FDMA”), Wideband CDMA (“W-CDMA”), Orthogonal Frequency-Division Multiple Access (“OFDMA”), Space-Division Multiple Access (“SDMA”), and the like.

In addition, the communications component 718 may facilitate data communications using General Packet Radio Service (“GPRS”), Enhanced Data services for Global Evolution (“EDGE”), the High-Speed Packet Access (“HSPA”) protocol family including High-Speed Downlink Packet Access (“HSDPA”), Enhanced Uplink (“EUL”) (also referred to as High-Speed Uplink Packet Access (“HSUPA”), HSPA+, and various other current and future wireless data access standards. In the illustrated embodiment, the communications component 718 can include a first transceiver (“TxRx”) 720A that can operate in a first communications mode (e.g., GSM). The communications component 718 also can include an Nth transceiver (“TxRx”) 720N that can operate in a second communications mode relative to the first transceiver 720A (e.g., UMTS). While two transceivers 720A-720N (hereinafter collectively and/or generically referred to as “transceivers 720”) are shown in FIG. 7, it should be appreciated that less than two, two, and/or more than two transceivers 720 can be included in the communications component 718.

The communications component 718 also can include an alternative transceiver (“Alt TxRx”) 722 for supporting other types and/or standards of communications. According to various contemplated embodiments, the alternative transceiver 722 can communicate using various communications technologies such as, for example, WI-FI, WIMAX, BLUETOOTH, infrared, infrared data association (“IRDA”), near field communications (“NFC”), other RF technologies, combinations thereof, and the like. In some embodiments, the communications component 718 also can facilitate reception from terrestrial radio networks, digital satellite radio networks, internet-based radio service networks, combinations thereof, and the like. The communications component 718 can process data from a network such as the Internet, an intranet, a broadband network, a WI-FI hotspot, an Internet service provider (“ISP”), a digital subscriber line (“DSL”) provider, a broadband provider, combinations thereof, or the like.

The mobile device 700 also can include one or more sensors 724. The sensors 724 can include temperature sensors, light sensors, air quality sensors, movement sensors, emotion sensors, accelerometers, magnetometers, gyroscopes, infrared sensors, orientation sensors, noise sensors, microphones proximity sensors, combinations thereof, and/or the like. Additionally, audio capabilities for the mobile device 700 may be provided by an audio I/O component 726. The audio I/O component 726 of the mobile device 700 can include one or more speakers for the output of audio signals, one or more microphones for the collection and/or input of audio signals, and/or other audio input and/or output devices.

The illustrated mobile device 700 also can include a subscriber identity module (“SIM”) system 728. The SIM system 728 can include a universal SIM (“USIM”), a universal integrated circuit card (“UICC”) and/or other identity devices. The SIM system 728 can include and/or can be connected to or inserted into an interface such as a slot interface 730. In some embodiments, the slot interface 730 can be configured to accept insertion of other identity cards or modules for accessing various types of networks. Additionally, or alternatively, the slot interface 730 can be configured to accept multiple subscriber identity cards. Because other devices and/or modules for identifying users and/or the mobile device 700 are contemplated, it should be understood that these embodiments are illustrative, and should not be construed as being limiting in any way.

The mobile device 700 also can include an image capture and processing system 732 (“image system”). The image system 732 can be configured to capture or otherwise obtain photos, videos, and/or other visual information. As such, the image system 732 can include cameras, lenses, charge-coupled devices (“CCDs”), combinations thereof, or the like. The mobile device 700 may also include a video system 734. The video system 734 can be configured to capture, process, record, modify, and/or store video content. Photos and videos obtained using the image system 732 and the video system 734, respectively, may be added as message content to an MMS message, email message, and sent to another device. The video and/or photo content also can be shared with other devices via various types of data transfers via wired and/or wireless communication devices as described herein.

The mobile device 700 also can include one or more location components 736. The location components 736 can be configured to send and/or receive signals to determine a geographic location of the mobile device 700. According to various embodiments, the location components 736 can send and/or receive signals from global positioning system (“GPS”) devices, assisted-GPS (“A-GPS”) devices, WI-FI/WIMAX and/or cellular network triangulation data, combinations thereof, and the like. The location component 736 also can be configured to communicate with the communications component 718 to retrieve triangulation data for determining a location of the mobile device 700. In some embodiments, the location component 736 can interface with cellular network nodes, telephone lines, satellites, location transmitters and/or beacons, wireless network transmitters and receivers, combinations thereof, and the like. In some embodiments, the location component 736 can include and/or can communicate with one or more of the sensors 724 such as a compass, an accelerometer, and/or a gyroscope to determine the orientation of the mobile device 700. Using the location component 736, the mobile device 700 can generate and/or receive data to identify its geographic location, or to transmit data used by other devices to determine the location of the mobile device 700. The location component 736 may include multiple components for determining the location and/or orientation of the mobile device 700.

The illustrated mobile device 700 also can include a power source 738. The power source 738 can include one or more batteries, power supplies, power cells, and/or other power subsystems including alternating current (“AC”) and/or direct current (“DC”) power devices. The power source 738 also can interface with an external power system or charging equipment via a power I/O component 740. Because the mobile device 700 can include additional and/or alternative components, the above embodiment should be understood as being illustrative of one possible operating environment for various embodiments of the concepts and technologies described herein. The described embodiment of the mobile device 700 is illustrative, and should not be construed as being limiting in any way.

As used herein, communication media includes computer-executable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared, and other wireless media. Combinations of the any of the above should also be included within the scope of computer-readable media.

By way of example, and not limitation, computer storage media may include volatile and non-volatile, removable and non-removable media implemented in any method or technology for storage of information such as computer-executable instructions, data structures, program modules, or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the mobile device 700 or other devices or computers described herein, such as the computer system 300 described above with reference to FIG. 3. In the claims, the phrase “computer storage medium,” “computer-readable storage medium,” and variations thereof does not include waves or signals per se and/or communication media, and therefore should be construed as being directed to “non-transitory” media only.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the personal physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations may take place in the mobile device 700 in order to store and execute the software components presented herein. It is also contemplated that the mobile device 700 may not include all of the components shown in FIG. 7, may include other components that are not explicitly shown in FIG. 7, or may utilize an architecture completely different than that shown in FIG. 7.

Based on the foregoing, it should be appreciated that aspects of motivational extended reality have been disclosed herein. Although the subject matter presented herein has been described in language specific to computer structural features, methodological and transformative acts, specific computing machinery, and computer-readable media, it is to be understood that the concepts and technologies disclosed herein are not necessarily limited to the specific features, acts, or media described herein. Rather, the specific features, acts and mediums are disclosed as example forms of implementing the concepts and technologies disclosed herein.

The subject matter described above is provided by way of illustration only and should not be construed as limiting. Various modifications and changes may be made to the subject matter described herein without following the example embodiments and applications illustrated and described, and without departing from the true spirit and scope of the embodiments of the concepts and technologies disclosed herein.

1. A method comprising:
creating, by a system comprising a processor, an identity token for a user;
storing, by the system in a data store, the identity token;
associating, by the system in the data store, the identity token with an input data source;
determining, by the system, an idealized image of the user;
associating, by the system in the data store, the idealized image with the identity token;
receiving, by the system, a real-world goal of the user;
associating, by the system in the data store, the real-world goal with the identity token;
receiving, by the system, data from the input data source;
monitoring, by the system, based upon the data received from the input data source, progress towards the real-world goal;
determining, by the system, whether the progress towards the real-world goal indicates that the real-world goal has been reached; and
in response to determining that the progress towards the real-world goal indicates that the real-world goal has been reached, allowing, by the system, access to the idealized image.

2. The method of claim 1, further comprising:
receiving a request to access the idealized image; and
exporting the idealized image in accordance with the request.

3. The method of claim 2, wherein exporting the idealized image comprises exporting the idealized image to a display.

4. The method of claim 3, wherein exporting the idealized image to the display comprises exporting the idealized image as a still image.

5. The method of claim 3, wherein exporting the idealized image to the display comprises exporting the idealized image as an extended reality image.

6. The method of claim 1, wherein the real-world goal comprises a plurality of milestones; wherein determining, by the system, whether the progress towards the real-world goal indicates that the real-world goal has been reached comprises determining, by the system, whether the progress towards the real-world goal indicates that a milestone of the plurality of milestones has been reached; and wherein in response to determining that the progress towards the real-world goal indicates that the real-world goal has been reached, allowing, by the system, access to the idealized image comprises in response to determining that the progress towards the milestone indicates that the milestone of the plurality of milestones has been reached, allowing, by the system access to at least a portion of the idealized image.

7. A system comprising:
a processor; and
a memory having instructions stored thereon that, when executed by the processor, cause the processor to perform operations comprising
creating an identity token for a user,
storing, in a data store, the identity token,
associating, in the data store, the identity token with an input data source,
determining an idealized image of the user,
associating, in the data store, the idealized image with the identity token,
receiving a real-world goal of the user,
associating, in the data store, the real-world goal with the identity token,
receiving data from the input data source,
monitoring, based upon the data received from the input data source, progress towards the real-world goal,
determining whether the progress towards the real-world goal indicates that the real-world goal has been reached, and
in response to determining that the progress towards the real-world goal indicates that the real-world goal has been reached, allowing access to the idealized image.

8. The system of claim 7, wherein the operations further comprise:
receiving a request to access the idealized image; and
exporting the idealized image in accordance with the request.

9. The system of claim 8, wherein exporting the idealized image comprises exporting the idealized image to a display.

10. The system of claim 9, further comprising the display.

11. The system of claim 9, wherein exporting the idealized image to the display comprises exporting the idealized image as a still image.

12. The system of claim 9, wherein exporting the idealized image to the display comprises exporting the idealized image as an extended reality image; and wherein the display comprises an extended reality display.

13. The system of claim 8, wherein:
the input data source comprises an Internet of Things device and the data comprises Internet of Things data;
the input data source comprises a personal data source application and the data comprises personal data; or
the input data source comprises a wearable device application executed by a wearable device and the data comprises wearable device data.

14. A computer-readable storage medium having computer-executable instructions stored thereon that, when executed by a processor, cause the processor to perform operations comprising:
creating an identity token for a user;
storing, in a data store, the identity token;
associating, in the data store, the identity token with an input data source;
determining an idealized image of the user;
associating, in the data store, the idealized image with the identity token;
receiving a real-world goal of the user;
associating, in the data store, the real-world goal with the identity token;
receiving data from the input data source;
monitoring, based upon the data received from the input data source, progress towards the real-world goal;
determining whether the progress towards the real-world goal indicates that the real-world goal has been reached; and
in response to determining that the progress towards the real-world goal indicates that the real-world goal has been reached, allowing access to the idealized image.

15. The computer-readable storage medium of claim 14, wherein the operations further comprise:
receiving a request to access the idealized image; and
exporting the idealized image in accordance with the request.

16. The computer-readable storage medium of claim 15, wherein exporting the idealized image comprises exporting the idealized image to a display.

17. The computer-readable storage medium of claim 16, wherein exporting the idealized image to the display comprises exporting the idealized image as a still image.

18. The computer-readable storage medium of claim 16, wherein exporting the idealized image to the display comprises exporting the idealized image as an extended reality image.

19. The computer-readable storage medium of claim 15, wherein the request comprises a request from a social media platform.

20. The computer-readable storage medium of claim 14, wherein:
the input data source comprises an Internet of Things device and the data comprises Internet of Things data;
the input data source comprises a personal data source application and the data comprises personal data; or
the input data source comprises a wearable device application executed by a wearable device and the data comprises wearable device data.
